(19) United States
(12) Patent Application Publication
(10) Pub. No.: US 2022/0140670 A1
(43) Pub. Date: May 5, 2022

(54) STATOR COOLING HOUSING FOR A STATOR OF A ROTARY ELECTRIC MOTOR

(71) Applicant: ETEL S.A., Motiers (CH)

(72) Inventor: Johann Pourchet, La Chaux de Gilley (FR)

(21) Appl. No.: 17/508,229

(22) Filed: Oct. 22, 2021

(30) Foreign Application Priority Data
Nov. 4, 2020 (EP) 20205752.7

(51) Int. Cl. H02K 1/20; H02K 9/19

(52) U.S. Cl. CPC H02K 1/20; H02K 9/19

(57) ABSTRACT

A stator cooling housing for a stator of a rotary electric motor includes a cylindrical frame adapted to be mounted around an iron core and having an outer lateral surface with cylindrical grooves or fins. The cylindrical frame includes a recess having a bottom part, at least one inlet channel, and at least one outlet channel. The stator cooling housing includes an add-on piece mounted into the recess, and a cylindrical jacket arranged against the outer lateral surface of the cylindrical frame to form with the cylindrical grooves or fins cylindrical cooling channels. The add-on piece includes a fluid cooling arrangement in fluid communication, on the one hand, with the inlet and outlet channel and, on the other hand, with the cylindrical cooling channels to form at least one cooling circuit.

### CROSS-REFERENCE TO RELATE APPLICATIONS

The present application claims priority to Application No. 20205752.7, filed in the European Patent Office on Nov. 4, 2020, which is expressly incorporated herein in its entirety by reference thereto.

### FIELD OF THE INVENTION

The present invention relates to a stator cooling housing for a stator of a rotary electric motor, to a stator including the stator cooling housing, and to a rotary electric motor including the stator. The present invention also relates to a method for manufacturing a stator cooling housing.

### BACKGROUND INFORMATION

Many solutions for cooling a stator of a rotary electric motor already exist.

European Patent Document No. 2 680 408, for example, describes a cylindrical frame for enclosing and cooling an iron core of a rotary electrical motor. The cylindrical frame includes two bundles of cooling ducts arranged on an outer lateral surface of the cylindrical frame. One of the bundles of cooling ducts guides cooling fluid from a coolant intake around circumference of the cylindrical frame. Coolant ducts, a reversal region and an outlet region are sealed by a cylindrical jacket that rests against an outer lateral surface of the frame. The jacket includes a slot arranged between the bundles of cooling ducts and between an intake region and the outlet region and is welded to the frame along the slot.

FIG. 1 is a perspective view of a cylindrical frame for cooling an iron core of a stator of a rotary electric motor, according to a conventional arrangement, in which the cylindrical frame is adapted to form two distinct cooling circuits, each including an inlet and an outlet port when a jacket is shrink fitted around the outer lateral surface of the frame.

These cylindrical frames have the advantage of being compact and having the cooling inlets and outlets on the same upper housing surface. The shape of the inlet and outlet channels must however by produced by milling which is a lengthy process which negatively impact the cost of the motor.

### SUMMARY

Example embodiments of the present invention provide a stator cooling housing that is readily manufactured and therefore cost-effective.

Example embodiments of the present invention provide a stator cooling housing with an improved ratio between its overall magnetic performance and its footprint.

According to an example embodiment of the present invention, a stator cooling housing for a stator of a rotary electric motor includes a cylindrical frame adapted to be mounted around an iron core and having an outer lateral surface with cylindrical grooves or fins. The cylindrical housing further includes a recess having a bottom part, at least one inlet channel, and at least one outlet channel. The stator cooling housing further includes an add-on piece mounted into the recess of the cylindrical frame, and a cylindrical jacket arranged against the outer lateral surface of the frame to form with the cylindrical grooves or fins cylindrical cooling channels. The add-on piece includes a fluid cooling arrangement in fluid communication, on the one hand, with the at least one inlet and outlet channels and, on the other hand, with the cylindrical cooling channels to form at least one cooling circuit.

The fluid cooling arrangement of the add-on piece may include grooves and fluid communication portions forming fluid channels with the bottom part of the recess. The fluid channels may be arranged to bring the at least one inlet channel and the at least one outlet channel in fluid communication with the cylindrical cooling channels.

The fluid channels may be arranged to bring a first set of inlet and outlet channels in fluid communication with a first portion of the cylindrical cooling channels, and a second set of inlet and outlet channels in fluid communication with a second portion of the cylindrical cooling channels to form two independent cooling circuits.

A plurality of sets of adjacent cylindrical fins may be arranged between adjacent radial extensions. The plurality of sets of adjacent cylindrical fins may form with the cylindrical jacket a corresponding plurality of cylindrical cooling channels with improved thermal exchange between the iron core and the cooling fluid when the stator cooling housing is operating.

The fluid cooling arrangement of the add-on piece may include an inlet duct arranged to bring an inlet channel in fluid communication with the uppermost cylindrical cooling channel and an outlet duct arranged to bring an outlet channel in fluid communication with the lowermost cylindrical cooling channel.

The outlet duct may extend across the add-on piece from its upper side to its lower side.

The cylindrical frame may include a plurality of radial extensions extending around the outer lateral surface from one lateral side to another opposite lateral side of the recess.

An outer side of the add-on piece may include parallel radial extensions extending from one lateral side to an opposite lateral side of the add-on piece to form several cylindrical extensions with only some of the plurality of radial extensions in order to create fluid communication between two adjacent grooves.

According to example embodiments of the present invention, a stator for a rotary electric motor includes a stator cooling housing as described herein above, and a rotary electric motor includes such a stator.

According to an example embodiment of the present invention, a method of manufacturing a stator cooling housing includes: machining a blank of a cylindrical frame, adapted to be mounted around an iron core, by a lathe to form cylindrical grooves or adjacent cylindrical fins around an outer lateral surface of the cylindrical frame; machining a recess on a portion of the outer lateral surface of the cylindrical frame; machining an upper cylindrical portion of the cylindrical frame to form at least one inlet channel and at least one outlet channel leading into the recess; producing an add-on piece that includes a fluid cooling arrangement; mounting the add-piece into the recess such that an inner side of the add-on piece rests against the bottom part of the recess; and adjusting a cylindrical jacket against the outer lateral surface of the cylindrical frame to form with the grooves or the fins cylindrical cooling channels in fluid communication with the fluid cooling arrangement of the add-on piece.

The add-on piece may be produced by an additive manufacturing or a molding process.

The add-on piece may be made of a high-temperature resistant rubber material and may be shrink fitted into the recess.

The inner side of the add-on piece may be glued against the bottom part of the recess.

The cylindrical jacket may be shrink fitted around the cylindrical frame.

Further features and aspects of example embodiments of the present invention are described in more detail below with reference to the appended schematic Figures.

### BRIEF DESCRIPTION OF THE DRAWINGS

FIG. 1 is a perspective view of a cylindrical frame adapted to be mounted around an iron core of a stator of a rotary electric motor, according to a conventional arrangement.

FIG. 2 is a perspective view of a cylindrical frame adapted to be mounted around an iron core according to an example embodiment of the present invention.

FIG. 3 is a perspective view of the cylindrical frame illustrated in FIG. 2 with a rectangular recess on the outer lateral surface of the cylindrical frame.

FIG. 4 is a perspective view of the cylindrical frame having an add-on piece mounted on the rectangular recess.

FIG. 5 is a perspective view of the add-on piece from an inner side thereof.

FIG. 6 is a perspective view of the stator cooling housing that includes a cylindrical jacket arranged against the outer lateral surface of the cylindrical frame illustrated in FIG. 4.

FIG. 7 is a perspective view of a cylindrical frame adapted to be mounted around an iron core of a rotary electric motor according to an example embodiment of the present invention.

FIG. 8 is a perspective view of the cylindrical frame illustrated in FIG. 7 with a rectangular recess on the outer lateral surface of the frame.

FIG. 9 is an axial cross-sectional view of a portion of the cylindrical frame illustrated in FIG. 8 that is diametrically opposed to the rectangular recess.

FIG. 10 is a perspective view of the cylindrical frame having an add-on piece mounted on the rectangular recess.

FIG. 11 is a perspective view of the add-on piece illustrated in FIG. 10.

FIG. 12 is an enlarged view of a portion of the cylindrical frame illustrated in FIG. 8 including the recess.

FIG. 13 is a perspective view of the stator cooling housing including a cylindrical jacket arranged against the outer lateral surface of the cylindrical frame illustrated in FIG. 10.

FIG. 14 is a cross-sectional view of the stator cooling housing illustrated in FIG. 13 taken along a first section through an inlet duct of the add-on piece.

FIG. 15 is a cross-sectional view of the stator cooling housing illustrated in FIG. 13 taken along a second section through an outlet duct of the addon-piece.

FIG. 16 is a cross-sectional view of the stator cooling housing illustrated in FIG. 13 taken along a third section showing cooling channels.

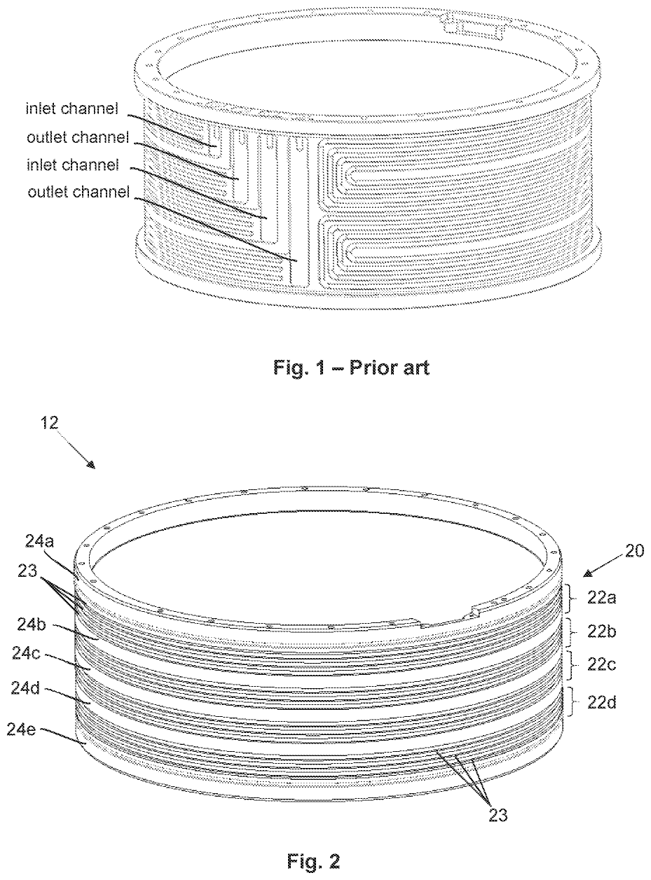

### DETAILED DESCRIPTION

FIG. 2 illustrates a cylindrical cage or frame 12, formed of metal, which is adapted to be mounted around an iron core of a stator, according to an example embodiment of the present invention. The metal frame is machined by a lathe to form a plurality of sets 22a, 22b, 22c, 22d of adjacent cylindrical fins 23 disposed between corresponding adjacent cylindrical extensions 24a, 24b, 24c, 24d, 24e. In this particular configuration, there are four sets of adjacent cylindrical fins 23 separated by five radial cylindrical extensions 24a, 24b, 24c, 24d, 24e although the number of sets of adjacent fins and radial cylindrical extensions may be different according to other configurations.

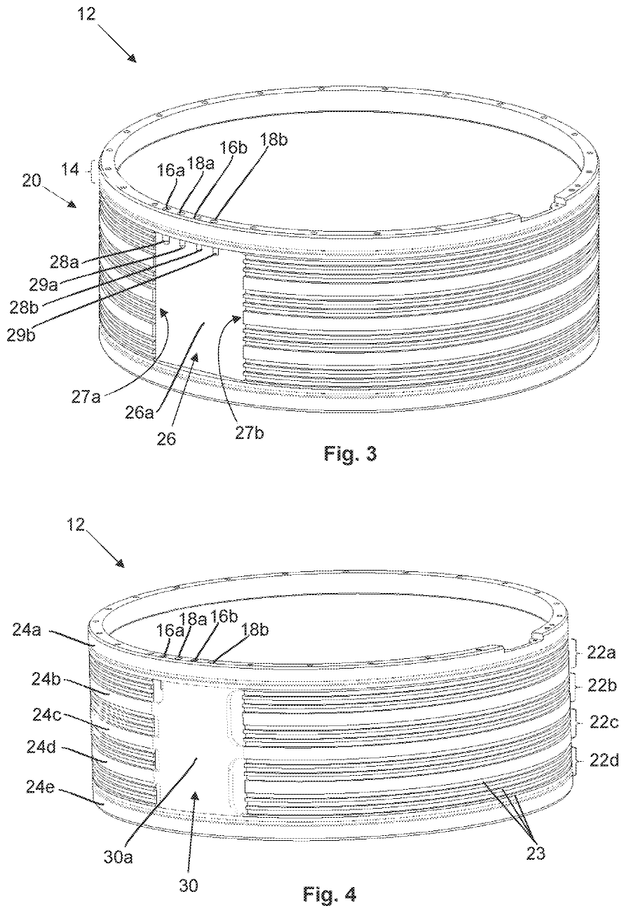

Referring to FIG. 3, a portion of the outer lateral surface 20 of the cylindrical frame 12 is milled to create a recess 26 with a bottom part 26a, which is, for example, a plane surface. The recess 26 has, for example, a rectangular shape extending from an upper portion to a lower portion of the cylindrical frame 12 and including first and second opposite lateral sides 27a, 27b. A first set of inlet and outlet channels 16a, 18a and a second set of inlet and outlet channels 16b, 18b are drilled through the upper portion 14 of the cylindrical frame 12 and through corresponding portions of the upper region of the bottom part 26a of the recess 26 to create a first and a second inlet groove 28a, 28b as well as a first and a second outlet groove 29a, 29b.

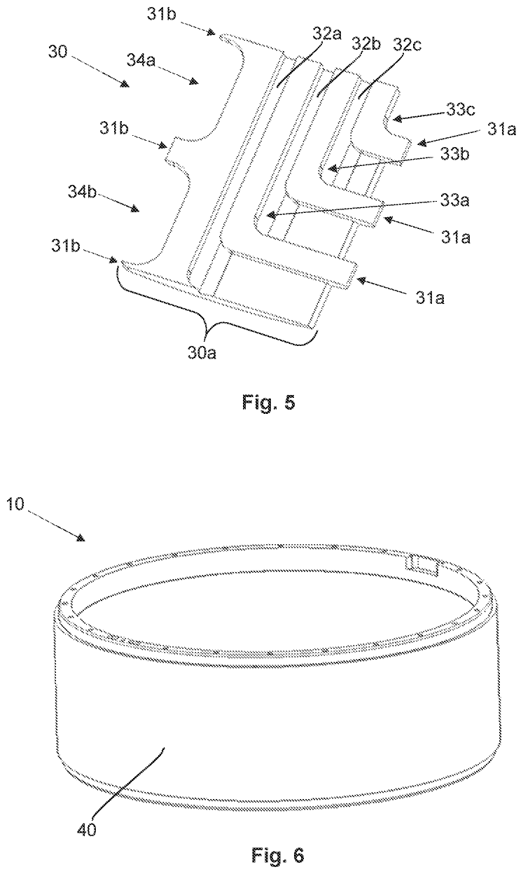

An add-on piece 30, illustrated in FIG. 5, is produced by an additive manufacturing process, or a molding process. The add-on piece 30 includes a fluid cooling arrangement 30a and is adapted to be shrink fitted inside the recess 26 as illustrated in FIG. 4. This add-on piece 30 is, for example, manufactured using high-temperature resistant rubber, which can withstand a shrink fitting operation and the various additives such as glycol which are, for example, used in cooling fluids. The add-on piece 30 may however be made of another material less malleable and may be glued against the bottom part 26a of the recess.

As illustrated in FIGS. 4 and 5, the add-on piece 30 includes a curved surface 30a on its outer side and the fluid cooling arrangement 30a on its inner side. The radius of curvature of the curved surface 30a corresponds substantially to the radius of curvature of the outer lateral surface 20 of the cylindrical frame 12 and the thickness of the add-on piece 30 corresponds to the depth of the recess 26 to form a smooth continuation through the interfaces between opposite lateral side portions 31a, 31b of the add-on piece 30 and the corresponding opposite lateral sides 27a, 27b of the recess 26.

The fluid cooling arrangement 30a of the add-on piece 30 is configured to create two distinct cooling circuits when a cylindrical jacket 40 is arranged around and against the outer lateral surface 20 of the cylindrical frame as illustrated in FIG. 6, for example, by a shrink fitting operation.

More particularly, the fluid cooling arrangement 30a of the add-on piece 30 of FIG. 5 includes three L-shaped raised portions 33a, 33b, 33c, three substantially L-shaped grooves 32a, 32b, 32c as well as a first and a second fluid communication portion 34a, 34b.

When the add-on piece 30 is shrink fitted into the recess 26 as illustrated in FIG. 4 and the cylindrical jacket 40 is arranged around and against the outer lateral surface 20 of the cylindrical frame, the bottom part 26a of the recess 26 forms with: the L-shaped raised portion 33c, an L-shaped channel that brings the first inlet channel 16a in fluid communication with a first end portion of the uppermost set 22a of adjacent cylindrical fins 23 located on the first side lateral side 27a of the recess 26; the first fluid communication portion 34a, a first semi-oblong cavity that brings a second end portion of the uppermost set 22a of adjacent cylindrical fins 23, located on the second lateral side 27b of the recess 26, in fluid communication with a first end portion of a second set 22b of adjacent cylindrical fins located on the same lateral side 27b of the recess 26; and the L-shaped groove 32c, an L-shaped channel that brings a second end portion of the second set 22b of adjacent cylindrical fins 23 in fluid communication with a first outlet channel 18a in order to form a first cooling circuit.

In addition, in the configuration set forth above, the bottom part 26a of the recess 26 forms with: the L-shaped groove 32b, an L-shaped channel that brings a second inlet channel 16b in fluid communication with a first end portion of a third set 22c of adjacent cylindrical fins 23 located on the first lateral side 27a of the recess 26; the second fluid communication portion 34b, a second semi-oblong cavity that brings a second end portion of the third set 22c of adjacent cylindrical fins 23, located on the second lateral side 27b of the recess 26, in fluid communication with a first end portion of a lowermost set 22d of cylindrical fins 23 located on the same lateral side 27b of the recess 26; and the L-shaped groove 32a, an L-shaped channel that brings a second end portion of the lowermost set 22d of cylindrical grooves in fluid communication with a second outlet channel 18b in order to form a second cooling circuit.

Under cooling operation, a first cooling liquid passes through the first cooling circuit, i.e., successively through the first inlet channel 16a, the first inlet groove 28a (see, FIG. 3) into the L-shaped channel (formed with the L-shaped raised portion 33c and the bottom part 26a of the recess), through the uppermost set 22a of adjacent cylindrical fins 23 in a clockwise direction around the cylindrical frame 12 spanning approximately 300° to 320°, into the first semi-oblong cavity, through the second set 22b of adjacent cylindrical fins in an anticlockwise direction around the cylindrical frame 12 spanning approximately 300° to 320°, through the L-shaped channel (formed with the L-shaped groove 32c and the bottom part 26a of the recess), and finally through the first outlet groove 29a and the first outlet channel 18a.

A second cooling liquid passes through the second cooling circuit, i.e., successively through the second inlet channel 16b, the second inlet groove 28b (see, FIG. 3), the L-shaped channel (formed with the L-shaped groove 32b and the bottom part 26a of the recess), through the third set 22c of adjacent cylindrical fins in a clockwise direction around the cylindrical frame 12 spanning approximately 300° to 320°, into the second semi-oblong cavity, through the lowermost set 22d of adjacent cylindrical fins in an anticlockwise direction around the cylindrical frame 12 spanning approximately 300° to 320°, through the L-shaped channel (formed with the L-shaped groove 32a and the bottom part 26a of the recess), and finally through the second outlet groove 29b and the second outlet channel 18b.

The different sets of adjacent cylindrical fins, for example, increase thermal exchange between the cooling fluid and the cylindrical frame of the stator mounted around the iron core, thereby providing a first and a second cooling circuit with improved reduction of the heat generated by the stator coils.

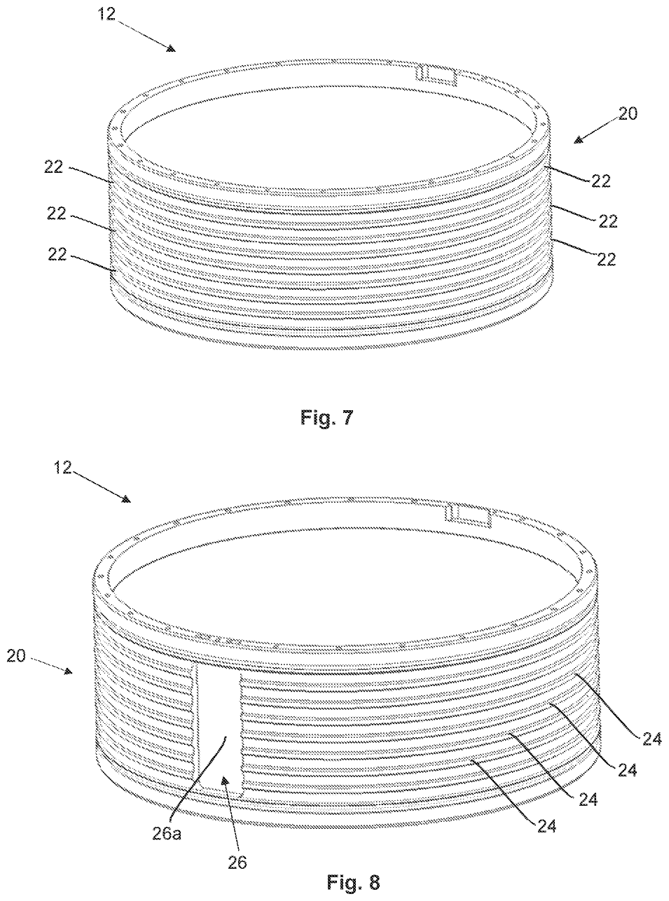

FIG. 7 illustrates a cylindrical frame 12 of a stator that is machined by a lathe to form cylindrical grooves 22 according to an example embodiment of the present invention. The cylindrical grooves 22 are regularly spaced apart from each other around the outer lateral surface 20 of the cylindrical frame 12 by radial cylindrical extensions 24 (see, FIG. 8).

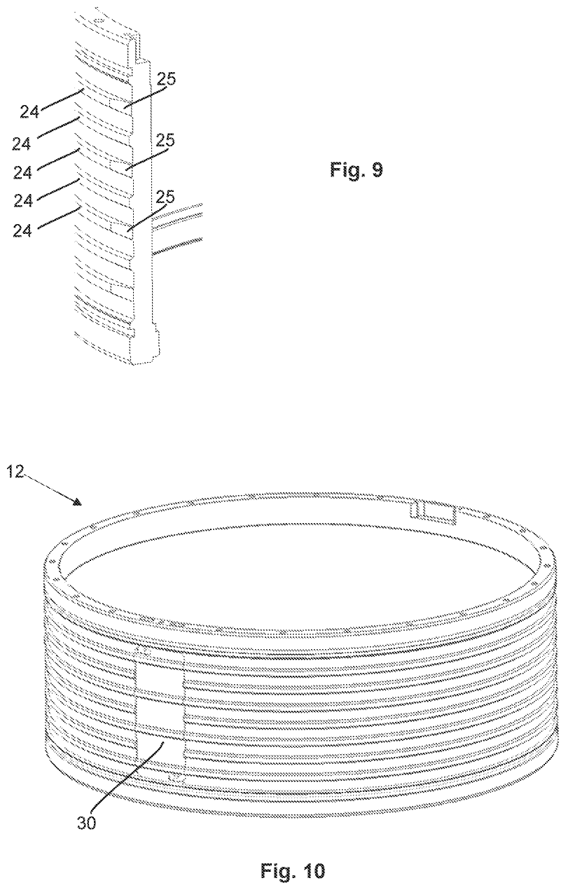

With reference to FIG. 8, a portion of the outer lateral surface 20 of the cylindrical frame is milled to create a recess 26 with a bottom part 26a, which is, for example, a flat surface. The recess 26 has, for example, a rectangular shape extending from an upper portion to a lower portion of the cylindrical frame 12. As illustrated in FIG. 9, the cylindrical frame 12 is machined such that every other cylindrical extension 24 includes a cut-off portion 25 diametrically opposed to the rectangular recess 26.

An add-on piece 30, illustrated in FIG. 11, is produced by an additive manufacturing process or molding a process and is shrink fitted into the recess of the cylindrical frame 12 as illustrated in FIG. 10.

The add-on piece 30 includes, on a front side, raised portions or extensions 38a, 38b, 38c, 38d with a constant width corresponding to the width of the cylindrical extensions 24 of the cylindrical frame 12. These raised portions extend from one lateral side to an opposite lateral side of the add-on piece 30 and are configured to form a continuous junction with every other cylindrical extension 24 at both interfaces between the lateral sides of the add-on piece 30 and the corresponding lateral sides 27a, 27b of the rectangular recess 26. The cut-off portions 25 and the raised portions 38a, 38b, 38c, 38d are offset by one cylindrical extension to form a cooling circuit.

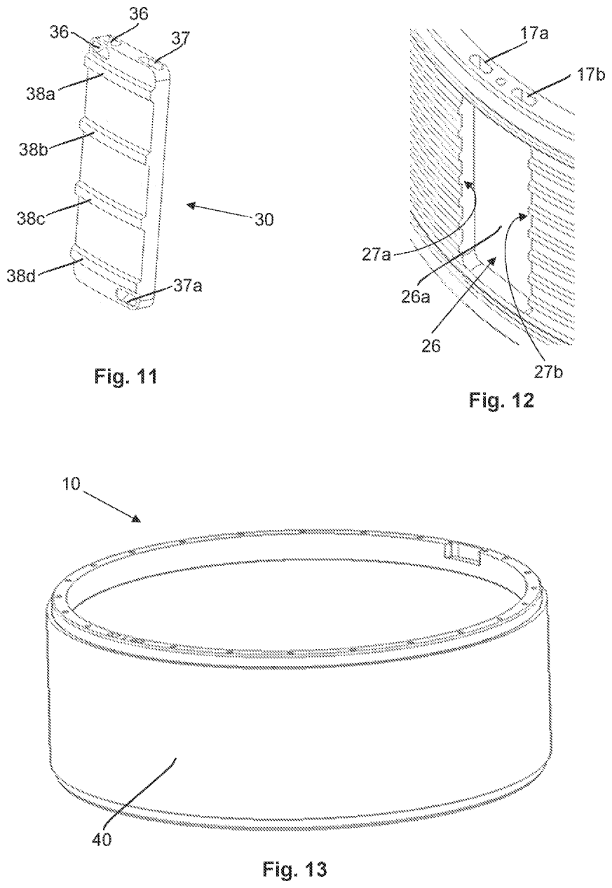

The add-on piece 30 illustrated in FIG. 11 includes an inlet duct 36 on its upper side and an outlet duct 37 extending from its upper side to its lower side. The upper portion of the cylindrical frame 12, as illustrated in FIG. 12, includes an inlet channel 17a and an outlet channel 17b both extending from a portion of a top annular surface into respectively the inlet and outlet ducts 36, 37 of the add-on piece 30.

The cooling circuit includes cylindrical cooling channels 50, as illustrated in FIG. 16, that are formed when the cylindrical jacket 40 is arranged around and against the outer lateral surface of the cylindrical frame as illustrated in FIG. 13, for example, by a shrink fitting operation.

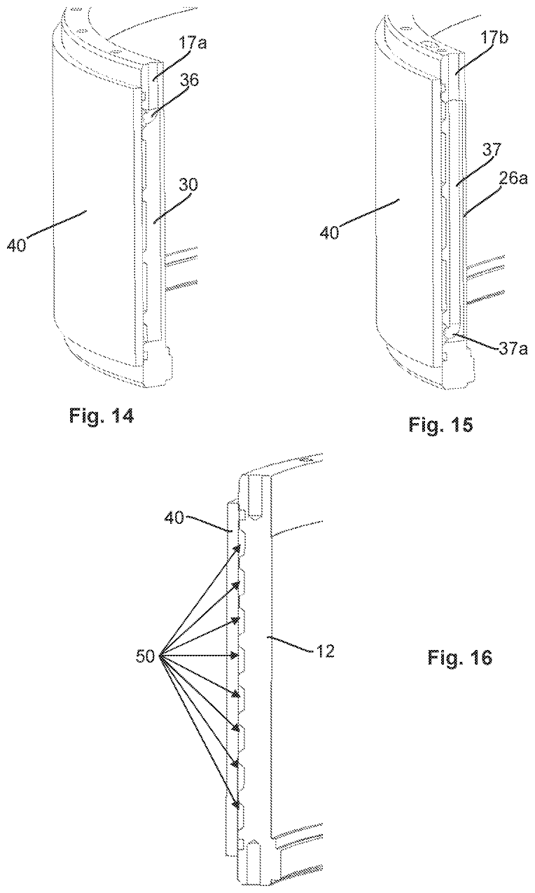

Under cooling operation, a cooling fluid is drawn from the inlet channel 17a into the inlet duct 36 (see, FIG. 14), which separates to pass through the uppermost cooling channel 50 in clockwise and counter-clockwise directions spanning approximately 180°, through a cut-off portion 25 into a lower cooling channel 50 (see, FIG. 16) in clockwise and counter-clockwise directions spanning approximately 180° until it reaches one interface between the add-on piece 30 and the cylindrical frame 12, whereupon the cooling fluid flows into a lower cooling channel 50 and so on until it reaches an end portion 37a of the outlet duct 37 as illustrated in FIG. 15, whereupon the cooling fluid flows in a upward direction along the outlet duct 37 to exit the outlet channel 17b. The cooling fluid therefore flows along clockwise and counterclockwise spiral paths around the outer lateral surface of the cylindrical frame 12.

Various modifications and variations to the example embodiments described herein may be made without departing from the spirit and scope hereof. For example, the grooves of the cylindrical frame may be replaced by cylindrical fins, and vice versa.

### LIST OF REFERENCE CHARACTERS

10 Stator cooling housing
12 Cylindrical frame
14 Upper cylindrical portion
16a, 16b First and second inlet channels
18a, 18b First and second outlet channels
17a, 17b Inlet and outlet channels
20 Outer lateral surface
22 Cylindrical grooves
22a, 22b, 22c, 22d Sets of adjacent fins
24; 24a, 24b, 24c, 24d, 24e Radial extensions
25 Cut-off portion
26 Recess
26a Bottom part
27a, 27b Lateral sides
28a, 28b First and second inlet grooves
29a, 29b First and second outlet grooves
30 Add-on piece
30a Fluid cooling arrangement
31 Curved surface
31a, 31b Lateral side portions
32a, 32b, 32c Grooves
33a, 33b, 33c L-shaped portions
34a, 34b Fluid communication portions
36 Inlet duct
37 Outlet duct
37a End portion
38a, 38b, 38c, 38d Radial extensions
40 Cylindrical jacket
50 Cooling channels

What is claimed is:

1. A stator cooling housing for a stator of a rotary electric motor, comprising:
a cylindrical frame adapted to be mounted around an iron core and including an outer lateral surface having cylindrical grooves and/or fins, the cylindrical frame including a recess having a bottom part, at least one inlet channel, and at least one outlet channel;
an add-on piece arranged in the recess; and
a cylindrical jacket arranged against the outer lateral surface of the cylindrical frame, cylindrical cooling channels being formed by the cylindrical jacket and the cylindrical grooves and/or fins;
wherein the add-on piece includes a fluid cooling arrangement in fluid communication with the inlet channel, the outlet channel, and the cylindrical cooling channels to form at least one cooling circuit.

2. The stator cooling housing according to claim 1, wherein the fluid cooling arrangement of the add-on piece includes grooves and fluid communication portions forming fluid channels with the bottom part of the recess, the fluid channels providing fluidic communication between the cylindrical cooling channels and the inlet and outlet channels.

3. The stator cooling housing according to claim 2, wherein the fluid channels provide fluidic communication between a first portion of the cylindrical cooling channels and a first set of inlet and outlet channels and provide fluidic communication between a second portion of the cylindrical cooling channels and a second set of inlet and outlet channels to form two independent cooling circuits.

4. The stator cooling housing according to claim 1, wherein a plurality of sets of adjacent cylindrical fins are arranged between adjacent radial extensions, the plurality of sets of adjacent cylindrical fins and the cylindrical jacket forming a corresponding plurality of cylindrical cooling channels that provide for improved thermal exchange between the iron core and a cooling fluid during operation of the stator cooling housing.

5. The stator cooling housing according to claim 1, wherein the fluid cooling arrangement of the add-on piece includes an inlet duct adapted to provide fluidic communication between the inlet channel and an uppermost cylindrical cooling channel and an outlet duct adapted to provide fluidic communication between the outlet channel and a lowermost cylindrical cooling channel.

6. The stator cooling housing according to claim 5, wherein the outlet duct extends between an upper side of the add-on piece and a lower side of the add-on piece.

7. The stator cooling housing according to claim 5, wherein the cylindrical frame includes a plurality of radial extensions extending around an outer lateral surface from one lateral side to an opposite lateral side of the recess.

8. The stator cooling housing according to claim 6, wherein the cylindrical frame includes a plurality of radial extensions extending around an outer lateral surface from one lateral side to an opposite lateral side of the recess.

9. The stator cooling housing according to claim 7, wherein an outer side of the add-on piece includes parallel radial extensions extending from one lateral side to an opposite lateral side of the add-on piece to form several cylindrical extensions with only some of the radial extensions to provide fluidic communication between two adjacent grooves.

10. A stator for a rotary electric motor, comprising:
a stator cooling housing including:
a cylindrical frame adapted to be mounted around an iron core and including an outer lateral surface having cylindrical grooves and/or fins, the cylindrical frame including a recess having a bottom part, at least one inlet channel, and at least one outlet channel;
an add-on piece arranged in the recess; and
a cylindrical jacket arranged against the outer lateral surface of the cylindrical frame, cylindrical cooling channels being formed by the cylindrical jacket and the cylindrical grooves and/or fins;
wherein the add-on piece includes a fluid cooling arrangement in fluid communication with the inlet channel, the outlet channel, and the cylindrical cooling channels to form at least one cooling circuit.

11. A rotary electric motor, comprising:
a stator including a stator cooling housing, the stator cooling housing including:
a cylindrical frame adapted to be mounted around an iron core and including an outer lateral surface having cylindrical grooves and/or fins, the cylindrical frame including a recess having a bottom part, at least one inlet channel, and at least one outlet channel;
an add-on piece arranged in the recess; and
a cylindrical jacket arranged against the outer lateral surface of the cylindrical frame, cylindrical cooling channels being formed by the cylindrical jacket and the cylindrical grooves and/or fins;
wherein the add-on piece includes a fluid cooling arrangement in fluid communication with the inlet channel, the outlet channel, and the cylindrical cooling channels to form at least one cooling circuit.

12. A method of manufacturing a stator cooling housing, comprising:
mounting an add-on piece, having a fluid cooling arrangement and an inner side, into a recess of a cylindrical frame, so that the inner side of the add-on piece rests against a bottom part of the recess, the cylindrical frame being adapted to be mounted around an iron core, and including an outer lateral surface having cylindrical grooves and/or fins, at least one inlet channel, and at least one outlet channel; and
adjusting a cylindrical jacket against the outer lateral surface of the cylindrical frame to form, with the cylindrical grooves and/or fins, cylindrical cooling channels in fluid communication with the fluid cooling arrangement of the add-on piece.

13. The method according to claim 12, wherein, in the manufactured stator cooling housing, the fluid cooling arrangement is in fluid communication with the inlet channel, the outlet channel, and the cylindrical cooling channels to form at least one cooling circuit.

14. The method according to claim 12, further comprising:
machining a blank of the cylindrical frame by a lathe to form the cylindrical grooves and/or fins around an outer lateral surface of the cylindrical frame;
machining the recess on a portion of an outer lateral surface of the cylindrical frame; and
machining an upper cylindrical portion of the cylindrical frame to form the inlet and outlet channels leading into the recess.

15. The method according to claim 14, further comprising producing the add-on piece.

16. The method according to claim 12, further comprising producing the add-on piece by an additive manufacturing process and/or a molding process.

17. The method according to claim 12, wherein the add-on piece is formed of a high-temperature resistant rubber material, and the add-on piece is mounted into the recess by shrink fitting the add-on piece into the recess.

18. The method according to claim 12, further comprising gluing the inner side of the add-on piece to the bottom part of the recess.

19. The method according to claim 12, further comprising shrink filling the cylindrical jacket around the cylindrical frame.

20. The method according to claim 12, wherein the manufactured stator cooling housing is arranged as recited in claim 1.
